(19) United States
(12) Patent Application Publication
(10) Pub. No.: US 2009/0012868 A1
(43) Pub. Date: Jan. 8, 2009

(54) Systems And Methods For Real-Time Allocation Of Digital Content

(76) Inventor: Douglas J. DeAngelis, Ipswich, MA (US)

Correspondence Address: LATHROP & GAGE LC, 4845 PEARL EAST CIRCLE, SUITE 300, BOULDER, CO, 80301, US

(21) Appl. No.: 12/209,894

(22) Filed: Sep. 12, 2008

Related U.S. Application Data
(63) Continuation-in-part of application No. 11/938,198, filed on Nov. 9, 2007.
(60) Provisional application No. 60/858,038, filed on Nov. 9, 2006.

(51) Int. Cl. G06Q 30/00; G06Q 40/00

(52) U.S. Cl. 705/14; 705/26; 705/37

(57) ABSTRACT

Systems, methods, and software products allocate digital content to advertising spaces in real time. Advertising space parameters for an advertising space are processed in an advertising space database. Sales parameters for the advertising space are processed in the advertising space database. Digital content is processed in a submitted content database. An advertising space owner is permitted access to the submitted content database for review of the digital content and approved digital content is tagged with an approval indicator. Bidding parameters for a time slot on the advertising space are processed and the time slot is auctioned to providers of the approved digital content. The approved digital content is distributed to the advertising space and winning digital content is aired during the time slot.

### RELATED APPLICATIONS

This application is a continuation-in-part of U.S. patent application Ser. No. 11/938,198, filed Nov. 9, 2007, which claims priority to U.S. Provisional Ser. No. 60/858,038, filed 9 Nov. 2006, each of which is incorporated herein by reference.

### BACKGROUND

Narrowcasting refers to the targeted transmission of audio and video content to a controlled and specific output device. In narrowcasting, the content provider caters subject matter to a limited number of people or a specific demographic group. Narrowcasting is now being applied to a new and innovative form of advertising and information dissemination commonly referred to as Dynamic Digital Signage. A Dynamic Digital Sign (DDS) is a device that can show still or moving video. The capability of Dynamic Digital Signage to help marketers effectively communicate with customers, to precisely target the most suitable demographic and obtain instant feedback on a product or service are invaluable to almost every business. This is especially crucial in fast-moving, highly competitive marketplaces where up-to-the-minute information about customers' needs and desires is utilized to both control costs and maximize sales. Dynamic Digital Signage is making noticeable inroads in retail businesses and in entertainment complexes such as movie theatres and sports venues. Transportation centers such as airports are also well suited to the technology.

Digital Signage Networks (DSN) provide content to multiple DDSs from a common source. Advertising is expected to drive the growth of DSNs since retailers are looking for new ways to reach their customers, and advertising agencies have been clambering for new ways to deliver their ads. Current DSN software and infrastructures follow a similar model; that is, they help the user create, manage, and distribute content to DDSs, and then offer verification when the content has aired. This DNS software thus makes sense when the entity creating the content also owns the distribution network. However, it does not provide for distribution of content to DSNs when multiple advertisers and multiple sign owners have a buyer/seller relationship in a distribution network.

Today, the majority of DSN owners stream their own digital content onto digital signs. However, when owners do sell time slots to advertisers, they are often required to enter into long-term contracts such as those used in the television and radio industries. This process can be cumbersome and may result in the DSN owner not having advertisements for certain time slots. For example if one potential advertiser pulls out of a negotiation for a particular, upcoming, time slot, there may not be enough time to work out a contract with another advertiser to fill that slot. The owner may simply be unable to sell a time slot if sufficient time prior to the time slot is not available.

### SUMMARY

In one embodiment, a system for real-time allocation of digital content to a digital sign includes a sign database with information representative of one or more digital signs. A submitted content database stores digital content from a content provider. The content in the submitted content database is reviewable by a sign owner. An auction engine matches the digital content to at least one of the digital signs, and a content distributor distributes the matched content to the digital sign.

In another embodiment, a method for real-time allocation of digital content to digital signs includes: processing sign parameters for a digital sign in a sign database; processing sales parameters for the digital sign in the sign database, processing digital content in a submitted content database; permitting access to the submitted content database for review of the digital content by a digital sign owner, and tagging digital content approved by the digital sign owner with an approval indicator. Bidding parameters for a time slot on the digital sign are processed, and the time slot auctioned to providers of the approved digital content. The content is distributed to the digital sign, and winning content is aired during the time slot.

In another embodiment, a software product has instructions stored on computer-readable media that, when executed by a computer, perform steps for real-time allocation of digital content to digital signs. The software product includes instructions for: obtaining data indicative of sign owner parameters; obtaining data indicative of content provider parameters; identifying content that is approved by the sign owner; carrying out an auction, and distributing approved content to digital signs.

In an embodiment, a system for displaying digital content received over a digital signage network from a remote digital content marketplace includes a digital sign; a receiver, coupled with the digital sign, for receiving digital content that is approved for display on the digital sign; a storage device in communication with the digital sign, for temporarily storing the approved content; a sensor for providing feedback representative of activity local to the digital sign to the receiver; and a transmitter coupled with the receiver, for transmitting the feedback to the digital content marketplace.

In another embodiment, a system for real-time allocation of digital content to a digital sign includes a database with digital sign information of one or more digital signs, and an auction engine for matching digital content to the one or more digital signs.

In a further embodiment, a method allocates digital content to digital signs in real-time. Sign parameters for a digital sign are processed in a sign database. Sales parameters for the digital sign are processed in the sign database. Digital content is processed in a submitted content database. Access to the submitted content database by a digital sign owner is permitted, for review of the digital content and digital content approved by the digital sign owner is tagged with an approval indicator. Bidding parameters for a time slot on the digital sign are processed and the time slot is auctioned to providers of the approved digital content based upon the bidding parameters and the sales parameters. The approved digital content is distributed to the digital sign and approved digital content of the winning provider is aired on the digital sign during the time slot.

In another embodiment, a method for displaying digital content on a digital sign includes accessing a database containing information about one or more digital signs. A digital sign is selected from the database, and digital content is submitted to the database for approval by an owner of the selected digital sign. Approval of the digital content is received from the owner and a bid entered for display of the digital content on the selected digital sign.

In one embodiment, a method for allocating and displaying digital content on dynamic digital signs includes: accepting dynamic digital sign sales parameters for one or more dynamic digital signs of a digital signage network; accepting proposed digital content for display upon at least one of the one or more dynamic digital signs; accepting bidding parameters associated with the proposed digital content; determining an auction close time based upon the dynamic digital sign sales parameters; entering bids to the auction based upon the bidding parameters; auctioning a time slot on the one or more dynamic digital signs based upon the entered bids; determining, at the auction close time, a winning bid; and distributing the digital content associated with the winning bid to the one or more dynamic digital signs for display.

In another embodiment, a method selects and displays digital content within an advertising space. Advertising space sales parameters for one or more advertising spaces are accepted. Proposed content for display within at least one of the one or more advertising spaces is accepted. Bidding parameters associated with the proposed content are accepted. An auction close time is determined based upon the advertising space sales parameters. Bids are entered to the auction based upon the bidding parameters. A time slot for the one or more advertising spaces is auctioned based upon the entered bids. A winning bid is determined at the auction close time and the content associated with the winning bid is distributed for display within the one or more advertising spaces.

In another embodiment, a system allocates digital content to an advertising space in real-time. An advertising space database includes information representative of one or more advertising spaces. A content database stores digital content from a content provider and is reviewable by an owner of the one or more advertising spaces. An auction engine matches the digital content to at least one of the advertising spaces and a content distributor distributes the matched content to the advertising space.

In an embodiment, a system allocates digital content to an advertising space in real time. The system has an advertising space database that includes information representative of one or more advertising spaces. The system also has a reviewable content database that stores digital content from at least one content provider. The system has an auction engine that matches the digital content to the advertising space, and a content distributor that distributes the matched digital content to the advertising space.

In another embodiment, a method allocates of digital content to advertising spaces in real-time. Advertising space parameters for an advertising space are processed in an advertising space database. Sales parameters for the advertising space are processed in the advertising space database. Digital content is processed in a submitted content database. An advertising space owner is permitted to access the submitted content database for review of the digital content. Approved digital content is tagged with an approval indicator. Bidding parameters for a time slot on the advertising space are processed and the time slot is auctioned to providers of the approved digital content. The approved digital content is distributed to the advertising space, and winning digital content is aired during the time slot.

In another embodiment, a software product has instructions, stored on computer-readable media, wherein the instructions, when executed by a computer, perform steps for real-time allocation of digital content to advertising spaces. The software product includes: instructions for obtaining data indicative of advertising space owner parameters; instructions for obtaining data indicative of content provider parameters; instructions for identifying approved content; instructions for carrying out an auction; and instructions for distributing approved content to one or more advertising spaces.

In another embodiment, a method allocates digital content to advertising spaces in real-time. Advertising space parameters for an advertising space are processed in an advertising space database. Sales parameters for the advertising space are processed in the advertising space database. Digital content is processed in a submitted content database. An advertising space owner is permitted access to the submitted content database, for review of the digital content. Approved digital content is tagged with an approval indicator. Bidding parameters for a time slot on the advertising space are processed and the time slot is auctioned to providers of the approved digital content based upon the bidding parameters and the sales parameters. The approved digital content is distributed to the advertising space and the approved digital content of the winning provider is aired on the advertising space during the time slot.

### BRIEF DESCRIPTION OF THE FIGURES

FIG. 1A shows one system for real-time allocation of digital content, in accord with an embodiment.

FIG. 1B shows a block diagram illustrating exemplary operation of an auction engine of the system of FIG. 1A.

FIG. 1C shows a block diagram illustrating exemplary operation of a content distributor of the system of FIGS. 1A and 1B, with bundled content.

FIG. 2 is a flowchart illustrating one method for real-time allocation of digital content, in accord with an embodiment.

FIG. 3A is a flowchart illustrating a method for inputting parameters from a digital sign owner

FIG. 3B is a flowchart illustrating a method for inputting parameters from a content provider.

FIG. 3C is a flowchart illustrating a method for reviewing new content.

FIG. 4 shows a dynamic digital sign in use on a highway, in accord with an embodiment.

FIG. 5 is a graph illustrating bidding and reserve pricing in the context of FIG. 4.

FIG. 6 schematically shows an exemplary embodiment of a system for real-time allocation of digital content, with auction software for facilitating auctioning, parameter input and content review as in FIGS. 3A-3C, in accord with an embodiment.

FIG. 7 shows one system for real-time allocation of digital content to one or more personal computers, in accord with an embodiment.

FIG. 8 schematically shows one exemplary system for real-time allocation of digital content to one or more virtual displays within a virtual world, in accord with an embodiment.

FIG. 9 shows one exemplary personal computer fitted with a permanent advertisement display screen, in accord with an embodiment.

FIG. 10A shows one exemplary personal computer configured to permanently display an advertising space, in accord with an embodiment.

FIG. 10B shows one exemplary personal communication device configured to permanently display an advertising space, in accord with an embodiment.

FIG. 11 shows one exemplary personal computer configured to permanently display an advertising space within a fixed portion of a display, in accord with an embodiment.

FIG. 12 shows one exemplary auction system for providing digital content to advertising spaces of computers and devices, in accord with an embodiment.

FIG. 13 shows one exemplary auction system for providing digital content to advertising spaces of web site, in accord with an embodiment.

### DETAILED DESCRIPTION

Through the system for real-time allocation of digital content to a dynamic digital sign (DDS) described hereinbelow, an owner of a DDS may sell time slots and assign content to or approve content for that DDS in real-time, based upon current market value. The assigned or approved content may be delivered to the DDS via hard wired communication paths, or the content may be delivered wirelessly. The system thus acts as an intermediate “marketplace” between content providers (i.e., advertisers or buyers of time slots) and sign owners (i.e., owners of a DDS and/or digital signage network (DSN)). Using the following DDS Content Marketplace methodology, regardless of the amount of eligible content, the time between the end of an auction for a time slot and the start of the time slot may be reduced to near zero, given sufficient link speed on the network and local storage on the DDS. Advantages of the system may thus be realized by both sign owners and content providers. That is, the DDS owner sells time slots at a market price based upon demand for the DDS; and the content provider pays a fair market value determined by competing bidders, and therefore does not risk overpaying. Content providers also have the flexibility to decide which time slots are most valuable for their particular messages.

Triggers may be set up by content providers and sign owners such that when the set trigger occurs, the time slot immediately following the trigger is bid upon (i.e., automatically, by the provider) or opened for bidding (i.e., automatically, by the owner). This is for example useful in a sporting event where a trigger is associated with a sponsored athlete breaking a league record. The content provider, in this case the athlete's sponsor, may take advantage of this trigger by having an appropriate advertising clip ready to play when and if the trigger occurs. The sponsor benefits from immediate association of their name and/or product with the record breaking event and the owner may receive a premium for that time slot, for example. Other triggers include, but are not limited to, temperature and other weather conditions, market conditions, traffic accidents and delays in public transportation.

The DDS Content Marketplace methodology described hereinbelow may provide a virtual “wall” between the sign owner and the content provider such that the lowest price the sign owner is willing to accept for a given time slot, and the highest price the content provider is willing to pay for a given time slot, remain private. The sign owner may create different pricing rules for the sign at any granularity (i.e., down to one minute or less) and set a “reserve” price, below which the sign plays a default clip (i.e., an advertisement for the DDS itself) or nothing at all.

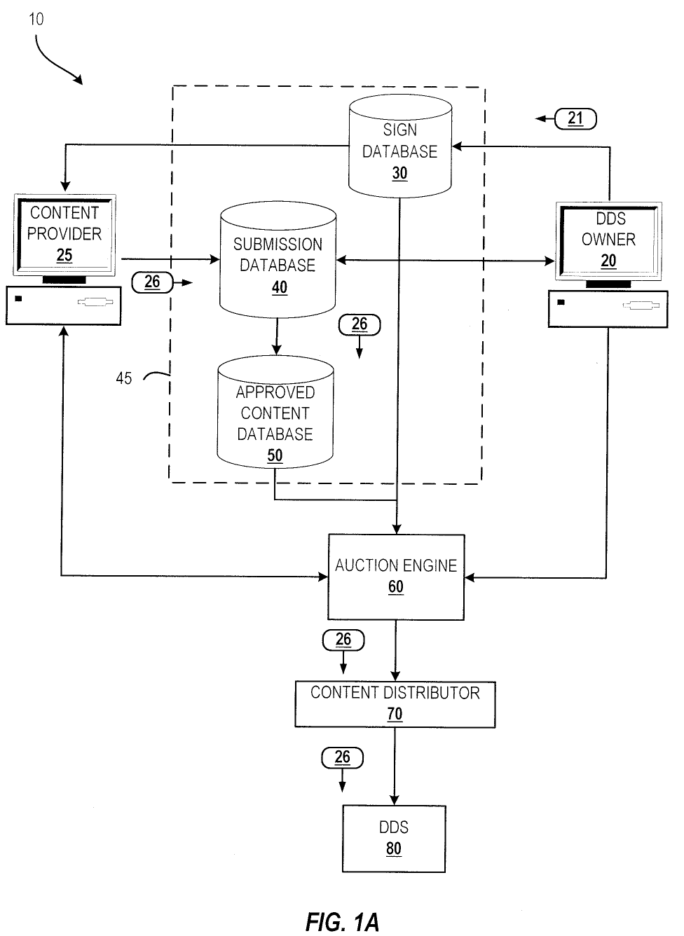

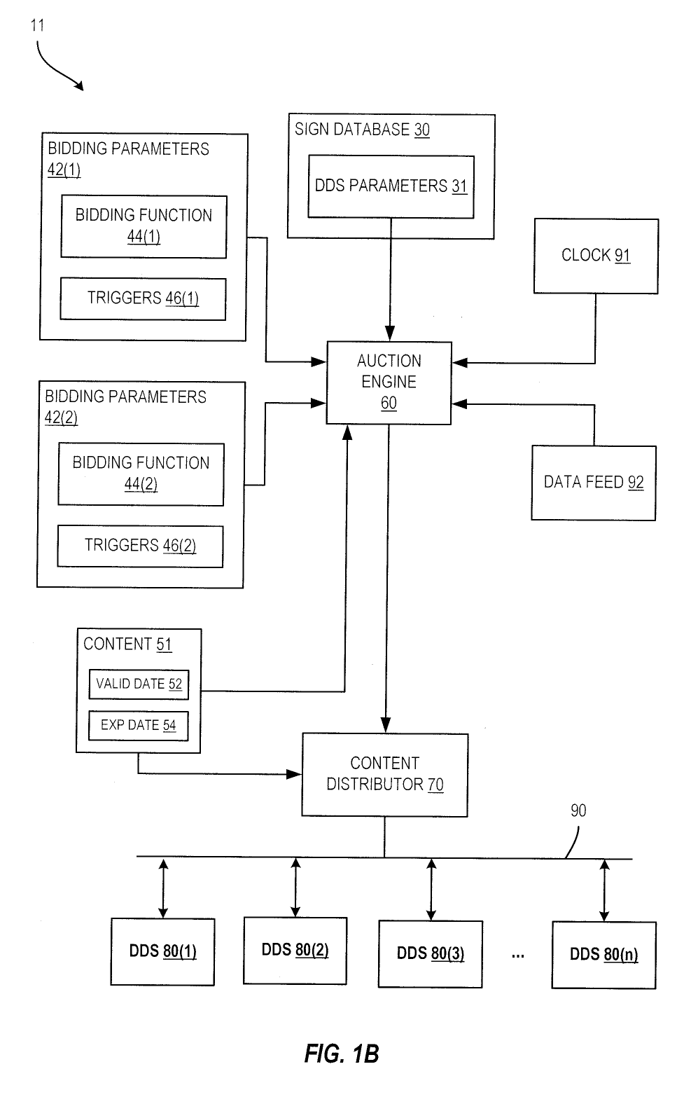

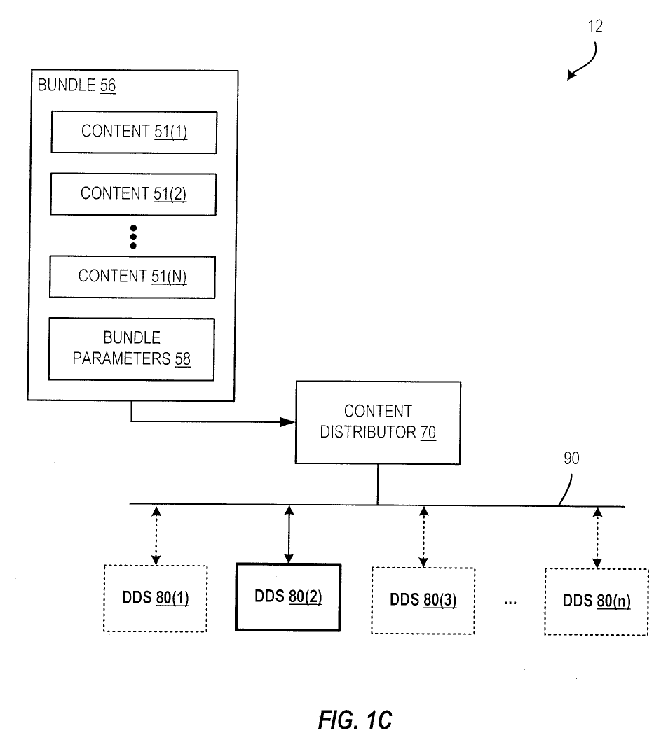

FIG. 1A schematically shows one system 10 for real-time allocation of digital content. A sign database 30 is populated with information (e.g., DDS information 21) of one or more DDSs (e.g., a DDS 80) owned by one or more DDS owners (e.g., DDS owner 20 that is shown as a computer terminal communicatively connected with system 10). Owner 20 for example pays a fee to register or list DDS 80 with system 10. Sign database 30 contains information of DDS 80 including pertinent details associated with selling display space and time on DDS 80. A content provider 25 (also shown as a computer terminal communicatively connected with system 10) searches sign database 30 for a sign that meets desired advertising criteria. In one example, content provider 25 accesses sign database 30 via the Internet using the illustrated computer terminal. Upon selecting a suitable DDS (e.g., DDS 80 in this example) from sign database 30, content provider 25 submits content 26, such as digital media that is properly formatted and tagged for DDS 80, to a submission database 40. Sign owner 20 accesses submission database 40 to evaluate content 26 submitted for DDS 80. If approved, content 26 is stored in an approved content database 50. Sign database 30, submission database 40 and approved content database 50 may be part of the same database 45, as shown. In one example, submission database 40 and approved content database 50 are subsets of a single content database (not shown). In one embodiment, submission database 40 and approved content database 50 are combined and include one or more fields associated with each item of submitted content, to indicate approval or disapproval for selected DDSs. Approved content database 50 thus includes content (e.g., content 26) that is suitable (per criteria of DDS owner 20) and ready to be played on DDS 80. Content provider 25 is therefore eligible to participate in an auction for one or more time slots of DDS 80 in which to display the content. Potential content for DDS 80 is “approved” by owner 20 in advance of any time slot auction associated with DDS 80, and may be loaded into memory of DDS 80 such that it is ready to be displayed on DDS 80. Content (e.g., content 26) may be approved by multiple DDS owners for playing on multiple DDSs.

An auction engine 60 matches content providers 25 to sign owners 20 based upon approved content for each DDSs (e.g., DDS 80), and then determines which, if any, approved content is selected for display upon each DDS using a bidding methodology. Auction engine 60 employs one or more bidding methodologies defined by each DDS owner (e.g., DDS owner 20). Bidding methodologies include, but are not limited to, fixed or variable price, pricing granularity, and using a traditional or reverse auction style. In an embodiment, auction engine 60 creates a virtual “wall” between content provider 25 and sign owner 20 such that the bidding methodology, the reserve price for time slots, the maximum bid and the latest bid are not available to the content providers and/or DDS owners (e.g., the DDS owner is not aware of the content providers maximum bid and the content provider is not aware of the reserve price for time slots).

Upon closing of an auction for a particular timeslot, auction engine 60 passes the identification of the winning content (content 26 in this example) and associated provider 25 to a content distributor 70. Content distributor 70 then distributes or allocates the winning content (or identification thereof where approved content has already been distributed and stored within memory of the DDS) to one or more DDSs (e.g., DDS 80) upon which it is to be displayed. Allocation or identification of content for example occurs in real-time, upon closing of the auction. Content distribution may be similar to distribution in existing DSNs, with enhancements to permit real time operation. Where a DDS has limited local storage, content distributor 70 may evaluate the speed of potential content distribution paths to ensure that the auction ends soon enough to allow any content to be delivered to the sign prior to scheduled display time. DDS 80 has local storage to hold approved content (e.g., sufficient local storage to hold all approved content for DDS 80 for an appropriate period, such as ten minutes). This local storage is updated by content distributor 70 to ensure that content for display upon the DDS is local prior to its designated time slot. Thus, when an auction ends, content distributor 70 transfers the identity of the winning content to DDS 80 and any content no longer required may be flushed from the DDS local storage.

In an embodiment, sign database 30, submission database 40, approved content database 50, auction engine 60 and content distributor 70 are located on a server that is accessible by both owner 20 and content provider 25. In another embodiment content distributor 70 is a wireless device that is remote from a server that includes databases 30, 40 and 50 and auction engine 60. Sign database 30, submission database 40, approved content database 50 and auction engine 60 may be located on a single server, multiple server(s) at a single location or multiple servers at a number of locations.

FIG. 1B shows a block diagram 11 illustrating exemplary operation of auction engine 60 of FIG. 1A. Sign database 30 has a set of DDS parameters 31 that define operational parameters of DDS 80. Auction engine 60 receives data relating to content 51 (e.g., within approved content database 50). For example, auction engine 60 utilizes tags associated with content 51 when determining eligibility of content for entry into the time slot auction. Such tags include information representative of bidding parameters 42. Bidding parameters 42 are for example input by content provider 25 when inputting new content into submission database 40. Content 51 represents content approved by DDS owner 20.

Content 51 may also have an associated valid date 52 that specifies a date range when content 51 may be shown. For example, valid date 52 is specified by the content provider (e.g., content provider 25) to define a period during which content 51 may be played. Content 51 may also have an associated expiry date 54 that specifies a date and time after which content 51 cannot be played on a particular DDS 80 without re-approval. For example, expiry date 54 is specified by a DDS owner 20 to require re-approval of content 51 after the specified expiry date 54. Valid date 52 and expiry date 54 are shown within content 51 but are preferably stored within approved content database 50.

Content distributor 70 is illustratively shown connecting to a DSN 90 with multiple DDSs 80(1)-80(n). Content distributor 70 and DDSs 80 may interconnect wirelessly. Optionally, DDSs 80 may be seamlessly added and removed to/from DSN 90.

Auction engine 60 determines auction close time for each time slot of each DDS 80 based upon DDS parameters 31 stored within sign database 30, and input from clock 91. DDS parameters 31 are, for example, entered by owner 20 to define sign location, times of sign operation, time slot or spot periods (e.g., start time and duration), a minimum price for each time slot or spot, number of pixels, resolution, refresh rate, the DDS connection bandwidth, anticipated visibility as a function of time of day, anticipated impression (e.g., number of viewers who will see the sign) as a function of time of day, anticipated impression as a function of an event proximate the DDS, length of impression, anticipated viewer demographics, acceptable content ratings, pricing granularity, type of auction and the like.

Clock 91 is a real time clock that provides the current time to auction engine 60. Data feed 92 is for example live input from a sporting event, live money market data, or any other live data feed, such as current temperature near the selected DDS. In one embodiment, each DDS returns local data to auction engine 60 via content distributor 70 and/or data feed 92.

Based upon the current time, received from clock 91, the defined time slot periods and the bandwidth, auction engine 60 determines a closing time for each time slot auction. The closing time is selected to allow sufficient time, prior to commencement of the auctioned slot, for determining a winning bid and uploading the wining content to the associated DDS 80 (if not already uploaded with other approved content, as described above). Where approved content is stored locally to each DDS, the connection bandwidth is less significant, and auction close times may be within seconds of each time slot start time. Thus, auction engine 60 may operate in real time, where auctions for each time slot of each DDS close moments prior to the start of the time slot.

Auction engine 60 may evaluate bidding parameters 42 associated with the bids of one or more content providers 25, to determine an auction winner. For example, each content provider 25 may specify bidding parameters 42 that govern play of his content on a DDS (or entry of his approved content into an auction). Bidding parameters 42 include, but are not limited to, bidding formulae 44 (also referred to herein as bidding functions 44) and triggers 46. Bidding parameters 42 and triggers 46 may also affect bidding according to factors such as sign pixels, sign resolution, sign refresh rate, spot or slot duration or time, times of sign operation, location of sign, anticipated impressions as a function of time of day, anticipated length of impression and anticipated viewer demographics.

Triggers 46 may provide input to bidding functions 44 that define bidding strategies. Where multiple time slots are selected for bidding upon, a content provider 25 for example specifies budget caps (e.g., a total amount of money available over a specified period) and repeat time intervals (i.e., minimum amount of time that must pass between consecutive airings of the same content) in bidding formulae 44. If the set budget cap is met, or if the repeat time interval is not met, content from a provider 25 does not play on a selected DDS, even if that content provider 25 is the “first winner” of a time slot auction. In another example, where information related to the bidding formulae is not available prior to commencement of an auction, provider 25's approved content may not enter the auction. The approved content may, for example, be held from entering one auction while it is tied up in another auction. Once the results of the other auction are known, the effects of the other auction on budget caps, time intervals or other bidding formulae may be determined and the approved content entered into subsequent auctions, if appropriate.

Triggers 46 may be entered such that bidding for a time slot auction only occurs when trigger 46 conditions are met. In one example, trigger 46(1) specifies that the DOW industrial average must be greater than a specified amount. Thus, associated content 51 only enters bidding for time slots when the DOW industrial average is greater than the specified amount.

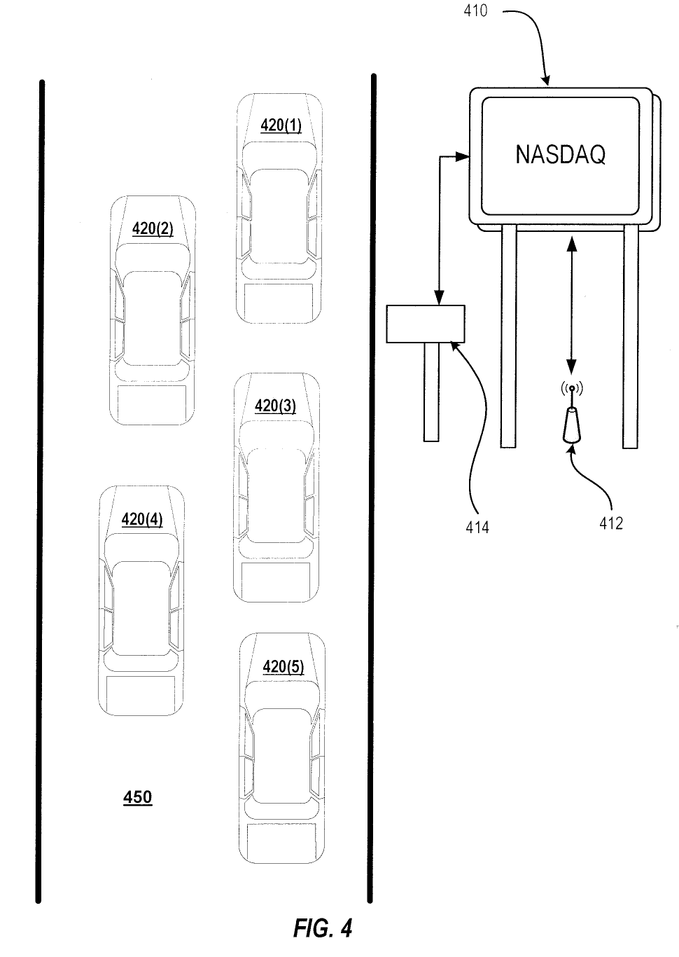

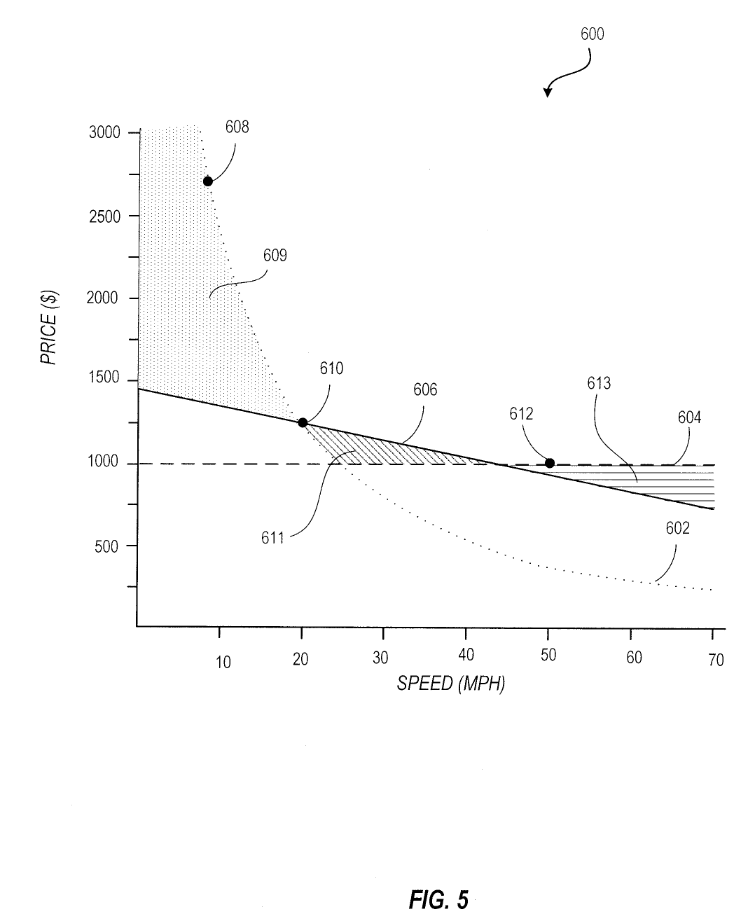

Similarly, bidding parameters 42(2) may for example specify that the DOW industrial average must be lower than the same specified amount. Thus, approved content of content provider 25 may automatically enter bidding based upon an external data feed 92 that delivers current DOW industrial average data to auction engine 60. In another example, bidding functions 44 may be defined to determine a maximum bid value based upon specified data feed values. Further examples of bidding functions 44 and triggers 46 are described in association with FIGS. 4 and 5. In one example, DDS owner 20 advertises appropriate data feed items that may be selected for use with bidding functions 44 and triggers 46, in association with a particular DDS 80.

In one embodiment, DDS parameters 31 also define a minimum and/or maximum content duration for the associated DDS 80. DDS owner 20 for example specifies time slots to be auctioned for each minute of an operational period and requires that display content be one minute in length. In another example, DDS owner 20 specifies a time slot duration of one minute and requires that content, or “spot,” duration is 5 minutes. Thus, for content to display, five consecutive time slots must be won.

Where DDS parameters 31 specify a reserve value for one or more time slots, no content is distributed by content distributor 70 if this value is not reached at the close of auction. Optionally, DDS owner 20 specifies default content, such as a public service announcement or the time of day, for display when the reserve value for a time slot is not met.

FIG. 1C shows a block diagram 12 illustrating exemplary operation of content distributor 70 of FIGS. 1A and 1B with bundled content 51(1)-51(N). A bundle 56 is formed of two or more associated content 51 (shown as content 51(1)-51(N), where N is an integer number greater than one) and bundle parameters 58 that specify one or more scheduling relationships for content 51(1)-51(N). For example, content provider 25 submits bundle 56 containing related media sequences approved as content 51(1)-51(N), bundle parameters 58 and one set of associated bidding parameters 42. Upon winning a time slot auction for DDS 80(2), content distributor 70 utilizes bundle parameters 58 to determine which of content 51(1)-51(N) to play within the timeslot. For example, bundle parameters 58 specify that each of content 51(1)-51(N) be selected in turn for display within won timeslots. In another example, bundle parameters 58 specify a ratio or percentage for display of each of content 51(1)-51(N).

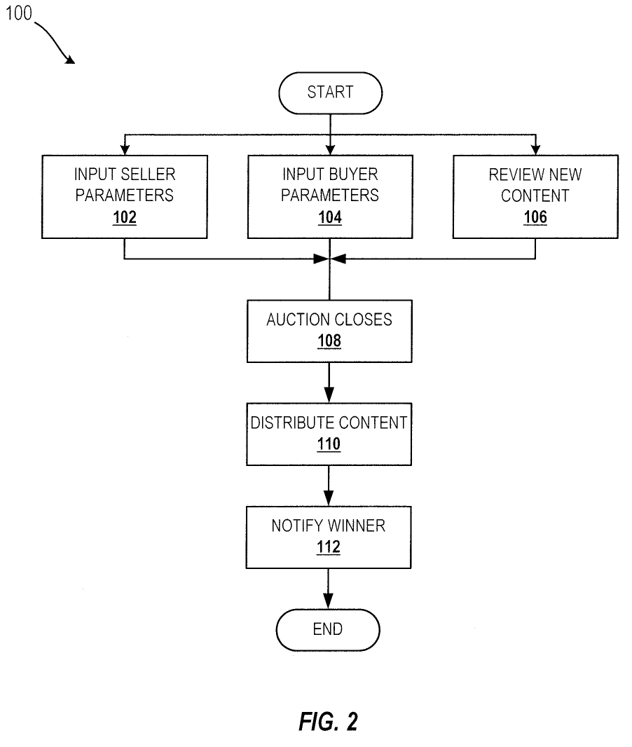

FIG. 2 is a flowchart illustrating one method 100 for real-time allocation of digital content. A DSN owner owns one or more digital signs on the network, and/or serves as manager of the network, for example charging a fee for managing the network and allowing sign owners 20 to associate their signs with the network. In one example, system 10 (FIG. 1A) follows the steps of method 100 to allow entry of parameters from both the sign owners (e.g., sign owner 20) and the content provider (e.g., content provider 25) to be entered prior to an auction being held to determine which content is displayed upon each DDS.

Step 102 of method 100 inputs seller parameters for one or more DDSs. In one example of step 102, owner 20 enters information of DDS 80 into system 10. In step 104, parameters are entered by a buyer/content provider. In one example of step 104, content provider 25 selects DDS 80 and enters new content for DDS 80 into system 10; the new content is stored in submission database 40. In step 106, the new content is reviewed by the appropriate DDS owner. In one example of step 106, owner 20 reviews the new content entered in step 104 to determine if it is acceptable for DDS 80; and, if so, the new content may be moved to approved content database 50. Steps 102, 104 and 106 may occur at any time prior to step 108. For example, owner 20 inputs parameters of DDS 80 for a particular time slot at any time prior to the close of the auction for that time slot, in step 108. Content provider 25 may submit new content for a particular time slot of DDS 80 at any time prior to the close of the auction for that time slot (step 108). Owner 20 may review the new content input in step 104, at any time prior to the close of the auction for the associated time slot (Step 108). Further, where there are multiple DDS owners, multiple content providers, multiple DDSs and multiple time slots for the DDS, steps 102, 104 and 106 may repeat many times prior to step 108.

In step 108, the auction closes and the bidding is evaluated to determine if and which content is to be displayed upon the associated DDS. In particular, step 108 occurs a certain period prior to each time slot of each DDS within system 10. In one example of step 108, system 10 determines that content provided by content provider 25 has won the auction for the next time slot of DDS 80. In step 110, method 100 distributes the winning content to the associated DDS. In one example of step 110, system 10 distributes the winning approved content from approved content database 50 to the associated DDS 80. In step 112, method 100 notifies the content provider who won the auction that their submitted content will be displayed upon the associated DDS in the associated time slot. In one example of step 112, system 10 sends a notification message to content provider 25 that submitted content for DDS 80 will be displayed. This notification message may include specific results of the auction closed in step 108, including the closing price.

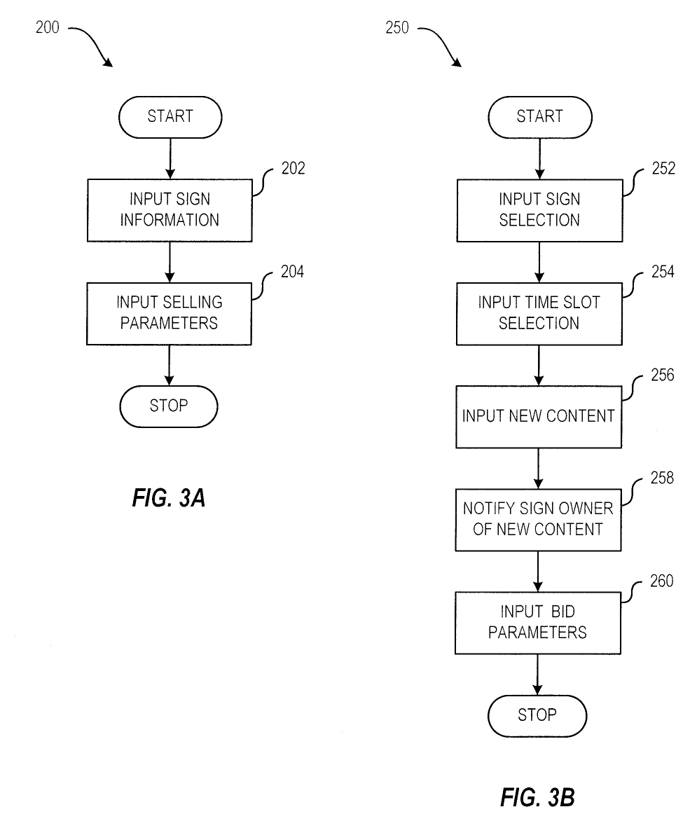

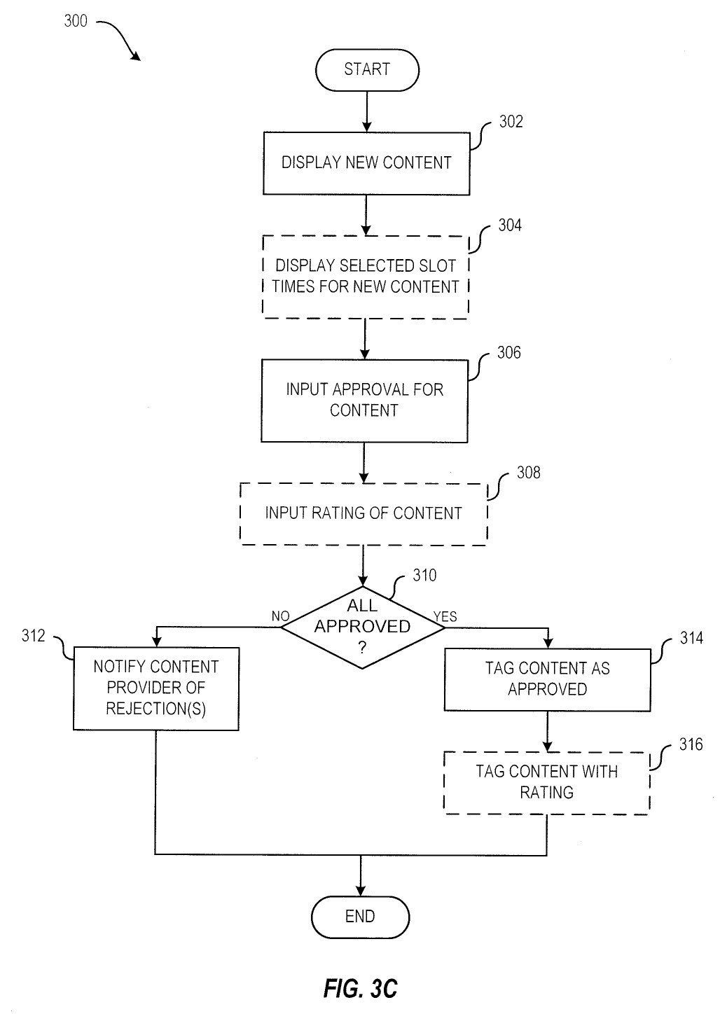

FIG. 3A is a flowchart illustrating one exemplary method 200 for inputting parameters from a DDS owner. Method 200 may represent step 102 of method 100, FIG. 2. In step 202, DDS information is input. In one example of step 202, DDS owner 20, FIG. 1A, inputs parameters of DDS 80 into system 10. These parameters for example include specifications of formats displayed by DDS 80, time slot availability and any further parameters input by the sign owner. In step 204, method 200 inputs selling parameters of the available DDS time slots. In one example of step 204, owner 20 inputs pricing formula for determining a minimum price for each time slot of DDS 80.

FIG. 3B is a flowchart illustrating one exemplary method 250 for inputting parameters from a content provider. Method 250 may represent step 104 of method 100, FIG. 2. In step 252, method 250 inputs selection of DDS. In one example of step 252, content provider 25, FIG. 1, selects DDS 80 for display of their new content. In step 254, method 250 inputs selection of one or more time slots for each of the DDS selected in step 252. In one example of step 254, content provider 25 selects one or more time slots of DDS 80 for display of their new content. In step 256, method 250 inputs new content for the selected DDS of step 252 and time slots of step 254. In one example of step 256, content provider 25 inputs new content into submission database 40 tagged for display on one or more time slots of DDS 80. In step 258, method 250 notifies the owner(s) of the signs selected in step 252 of new content awaiting review. In one example of step 258, system 10 sends a message informing owner 20 of new content input by content provider 25 that is associated with DDS 80. In step 260, method 250 inputs bid parameters associated with the selected sign, selected time slots and input content of steps 252, 254 and 256, respectively. In one example of step 260, content provider 25 inputs one or more formulae that define the bidding associated with the new content provided for display upon DDS 80 and selected time slots thereof.

FIG. 3C is a flowchart illustrating one exemplary method 300 for reviewing new content. Method 300 may represent step 106 of method 100, FIG. 2. In step 302, the new content is displayed to the owner of the associated DDS. In one example of step 302, system 10 displays the new content input in step 256 of method 250, FIG. 3B, to owner 20. Step 304 is optional, occurring if the new content is to be approved for display at various slot times. In step 304, method 300 displays selected slot times associated with the new content. In one example of step 304, system 10 displays selected slot times associated with the new content to owner 20. In step 306, method 300 inputs approval, or disapproval, from the owner of the DDS. In one example of step 306, owner 20 inputs approval of the new content provided by content provider 25 for DDS 80. Step 308 is optional, occurring if the new content is to be rated, e.g., for display at various slot times. In step 308, a rating for the new content is input. The rating for example indicates the content's suitability for display at various periods through the day. Step 310 is a decision. If, in step 310, the new content has been approved for all selected time slots, method 300 continues with step 314; otherwise method 300 continues with step 312. In step 312, method 300 notifies the content provider of the new content that it has not been approved. The content provider may then modify the content and resubmit it for approval in all time slots, or withdraw the content from non-approved time slots. The content provider for example modifies the time slots selected in step 254, FIG. 3B, to include only those time slots for which the content has been approved.

In step 314, method 300 tags the new content as approved. In one example of step 314, system 10 moves the new content from the submissions database 40 to the approved content database 50. Step 316 is optional, occurring if the new content is rated. In step 316, the new content is tagged with the rating determined in step 308. In one example, the new content is tagged with a “PG” rating. If the sign owner has indicated acceptable ratings for additional available time slots on the DDS (e.g., in step 202 of method 200 (FIG. 3A)), the content provider may bid to display the tagged content at an additional time slot that accepts “PG” content, without requiring further approval from the sign owner.

FIG. 4 illustrates one application of system 10, FIG. 1, for real-time allocation of digital content described herein. A DDS 410 is shown adjacent to a highway 450 and attached to a remote DSN through a wireless transceiver 412. Wireless transceiver 412 may continually or periodically receive and locally store content for future display. A sensor 414, in communication with system 10, detects the current speed of automobiles 420(1)-420(5) on highway 450. Sensor 414 relays information representative of automobile speed to system 10, for example via wireless transceiver 412, for use by a content provider, sign owner or both. The sign owner then sets reserve prices for time on digital sign 410 based on the average or current speed in a specific time slot. For example, when automobiles 420(1)-420(5) are in a traffic jam due to rush hour or an unforeseen event, the sign owner may wish to raise reserve prices for advertising to an essentially captive audience. Sign owners may provide traffic speed statistics or real-time data to content providers, who may be willing to pay a premium to advertise during traffic jams. For example, a sign owner posts or automatically directs traffic speed information to system 10, for access by content providers. As bids are entered and as bids fluctuate, e.g., due to traffic conditions mentioned above, system 10 continually updates auction status to indicate the current “winner.”

FIG. 5 is a graph 600 illustrating one example of dynamic bidding and bid tracking. For ease of illustration, FIG. 5 is described in the context of FIG. 4, and the following description may be best understood by viewing FIGS. 4 and 5 together. For ease of illustration, FIG. 5 is described in terms of one-minute advertisements. However, it will be understood that content and time slots may be less or more than one minute. Likewise, the content may be a still image that a content provider wishes to display for the duration of a slot, e.g., for twenty seconds.

As shown in FIG. 5, a first content provider and a second content provider have one-minute adds, both approved for play on a digital sign, such as DDS 410, FIG. 4. The sign owner has selected a traditional auction with a dynamic reserve price (indicated by line 602) of

$$\frac{\$20 , 000}{mph} ,$$

for one minute of air time at 5:00 PM. The denominator, mph, is for example defined within limits of the law and predicted traffic flow, e.g., as ten to 75 mph. In this example, the 5:00 time slot has a reserve price of $500 if automobiles 420(1)-420(5) move at 50 mph, and a reserve price of $1000 if they move at 25 mph.

The first content provider has entered a flat bid of $1,000 (indicated by line 604) for the 5:00 time slot, regardless of car speed. The second content provider has defined a bidding function of $700+$10(75-mph), indicating a base bid of $700, plus an additional $10 for every mph under 75. The second content provider's bidding function is represented by line 606. For ease of illustration the sign owner, first content provider and second content provider are referred to by their bidding line numbers, as owner 602, first provider 604 and second provider 606.

At point 608, traffic is moving at about 10 mph. At this speed, the reserve price for the 5:00 slot is:

$$\frac{\$25 , 000}{10} = \$2500 \qquad Eq . 1$$

Provider 604's flat bid is well beneath the reserve. Provider 606's dynamic bid likewise falls below the reserve:

$700+$10(75−10)=$1350 Eq. 2.

If the auction ends at point 608, e.g., due to time constraints, neither first or second content provider 604 or 606 wins, and sign 410 may remain blank, play an advertisement for time on sign 410 or play a public service announcement. Zone 609 illustrates a range of price and speed conditions under which sign 410 would remain blank or play such an add or announcement.

At point 610, traffic is moving at about 20 mph. At this speed, owner 602's dynamic reserve price for the 5:00 time slot is:

$$\frac{\$25 , 000}{20} = \$1250 \qquad Eq . 3$$

Provider 604's flat bid does not equal the reserve price set by owner 602; however, provider 606's dynamic bid has met the reserve price:

$700+$10(75−20)=$1250 Eq. 4

Thus, at point 610, provider 606 is winning the auction. Zone 611 illustrates a range of speed and price conditions where provider 606 wins the auction.

At point 612, traffic is moving at about 50 mph, hence, provider 604's flat bid of $1000 beats both the dynamic reserve and the dynamic bid set by provider 606. For example, at point 612, owner 602's dynamic reserve is:

$$\frac{\$25 , 000}{50} = \$500 \qquad Eq . 5$$

and provider 606's bid is:

$700+$10(75−50)=$925 Eq. 6.

Were the auction to end at point 612, provider 604 would win, and his or her approved content would play on sign 410. Zone 613 shows exemplary speed/price conditions where provider 604 wins the auction. This assumes that provider 604 has not entered additional bidding parameters that would cause withdrawal of his or her bid. In one example, provider 604 bids to play identical approved content on both the 5:00 slot and an earlier 4:45 PM slot, and enters a bidding parameter requiring 20 minutes to elapse between consecutive displays of the same approved content. If provider 604 wins the 4:45 slot, his or her bid is automatically withdrawn from the 5:00 auction. In another example, provider 604 wishes to air a two-minute advertisement, and must therefore win both the 5:00 time slot and a 5:01 timeslot on sigh 410. Provider 604 sets a bidding parameter that withdraws or blocks his or her bid if the 5:01 time slot is not won, for example by 4:58 PM. If the 5:01 time slot is not won, provider 606 wins the auction.

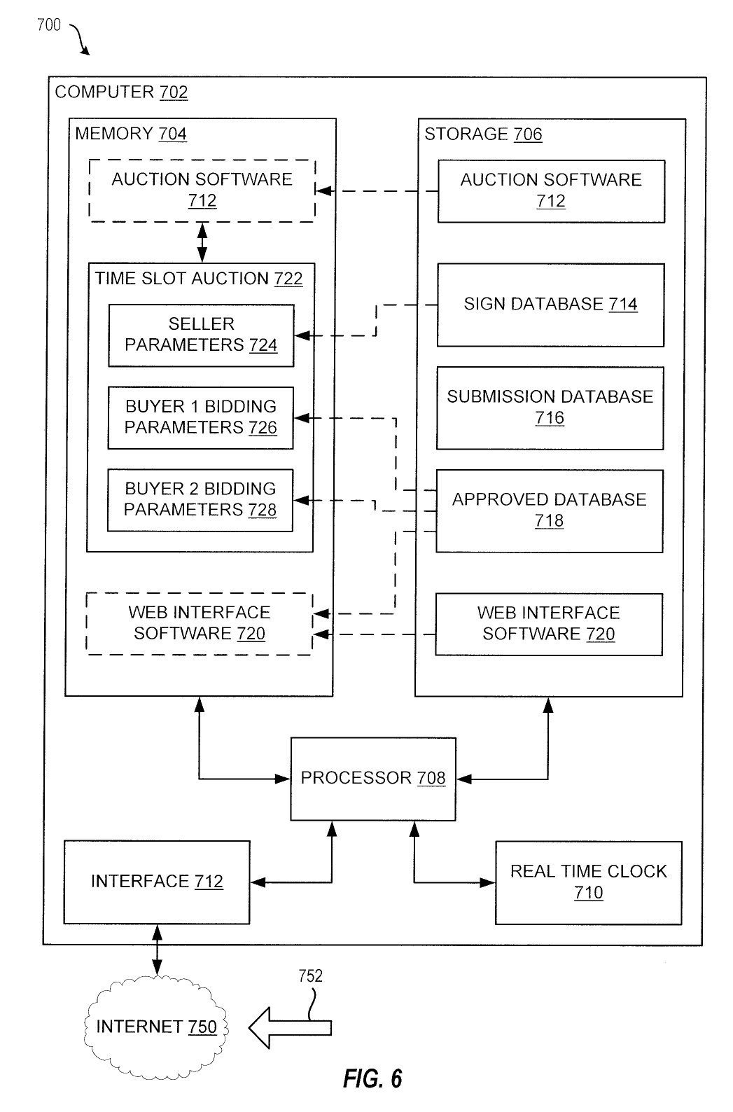

FIG. 6 schematically shows an exemplary embodiment of a system 700 for real-time allocation of digital content, with auction software for facilitating auctioning, parameter input and content review as in FIGS. 3A-3C. For ease of illustration, system 700 is described with respect to FIGS. 4 and 5, above.

System 700 includes a computer 702 having a memory 704, internal storage 706, a processor 708, an interface 712 and a real time clock 710. Memory 704 is, for example, random access memory (RAM). Internal storage 706 is, for example, a magnetic disk drive or other non-volatile storage medium. Optionally, storage 706 is augmented or replaced with external storage in communication with computer 702. Storage 706 is shown with auction software 712, a sign database 714, a submission database 716, an approved database 718 and web interface software 720. Auction software 712 may for example provide functionality of auction engine 60, FIG. 1. Web interface software 720 may represent a web server that provides access to databases 714, 716 and 718 via interface 712 and internet 750. Databases 714-718 for example include information submitted to sign database 30, submission database 40 and approved content database 50 (FIG. 1A), respectively.

Processor 708 loads auction software 712 and web interface software 720 into memory 704 for execution. Auction software 712 and web interface software 720 are shown in dashed outline within memory 704 for purpose of illustration. In the example of FIG. 6, memory 704 also includes information pertaining to a time slot auction 722 of one or more time slots of road-side DDS 410, FIG. 4. Time slot auction 722 is shown with seller parameters 724, buyer 1 bidding parameters 726 and buyer 2 bidding parameters 728. Seller parameters 724 are, for example, retrieved from database 714 by auction software 712. Buyer 1 bidding parameters 726 and buyer 2 bidding parameters 728 are, for example, retrieved from approved database 718 by auction software 712 based upon the DDS and time slot of time slot auction 722. Buyer 1 bidding parameters 726 and buyer 2 bidding parameters 728 may each include bidding functions (e.g., bidding function 44, FIG. 1B) and triggers (e.g., triggers 46) that define auction bids input by two content providers (e.g., content providers 25, FIG. 1A) for a time slot, such as a one minute time slot at 5 PM of DDS 410. In this example, auction software 712, using real time clock 710, loads time slot auction 722 into memory 704 at close of the auction for this time slot.

In one example, seller parameters 724 include the dynamic reserve price of

$$\frac{\$20 , 000}{mph} ,$$

for one minute of air time at 5:00 PM, set by sign owner 602 (FIG. 5). Buyer 1 bidding parameters 726 include the $1,000 flat bid set by provider 604. Buyer 2 bidding parameters 728 include the bidding function ($700+$10(75-mph)) set by provider 606. Seller and buyer parameters 724-728 are entered into databases 714, 716 and 718 of system 700 by owner 602 and content providers 604, 606, e.g., via Internet 750, interface 712 and web interface software 720, at any time prior to the close of the auction for this time slot.

Sensor 414, FIG. 4, periodically sends information (illustratively shown as arrow 752) representative of automobile speed 420(1)-420(5) on highway 450 to system 700, for example via wireless transceiver 412 and Internet 750. Auction software 712 utilizes this information to evaluate the dynamic reserve price of seller parameters 724 and the bidding function of buyer 2 bidding parameters 728 to determine the winner of time slot auction 722. As shown and described with respect to FIG. 5, if sensor 414 determines automobile speed as 20 mph, buyer 2 bidding parameters 728 dictate that buyer 2 wins the auction; if sensor 414 determines automobile speed to be 50 mph, buyer 1 bidding parameters 726 result in a win; and if sensor 414 determines an automobile speed of 10 mph, neither buyer 1 bidding parameters 726 nor buyer 2 bidding parameters 728 lead to a win, since the determined reserve price specified by seller parameters 724 is reached. Information from sensor 414 may also determine whether a buyer's content enters active bidding. For example, buyer 1 may set a bidding trigger at 50 mph or less, such that buyer 1's content does not enter (or is removed from) bidding if traffic is moving faster than 50 mph immediately prior to a desired time slot. Information from sensor 414 may also be received by sensor 700 at any time prior to auction or at the close of auction.

At each auction close for each time slot of each DDS, as determined by auction software 712 (e.g., using real time clock 710 and databases 714, 716 and 718), seller parameters and buyer parameters are evaluated to determine a winner of the auction. Auction software 712 then instructs content distributor 70 (FIG. 1A) to distribute and/or initiate display of the associated content on the associated DDS. For example, where content is stored locally at the DDS, auction software 712 initiates display of the content by sending a message to the DDS, for example via interface 712 and internet 750. The message may include instructions to delete losing content from the DDS and to air the winning content.

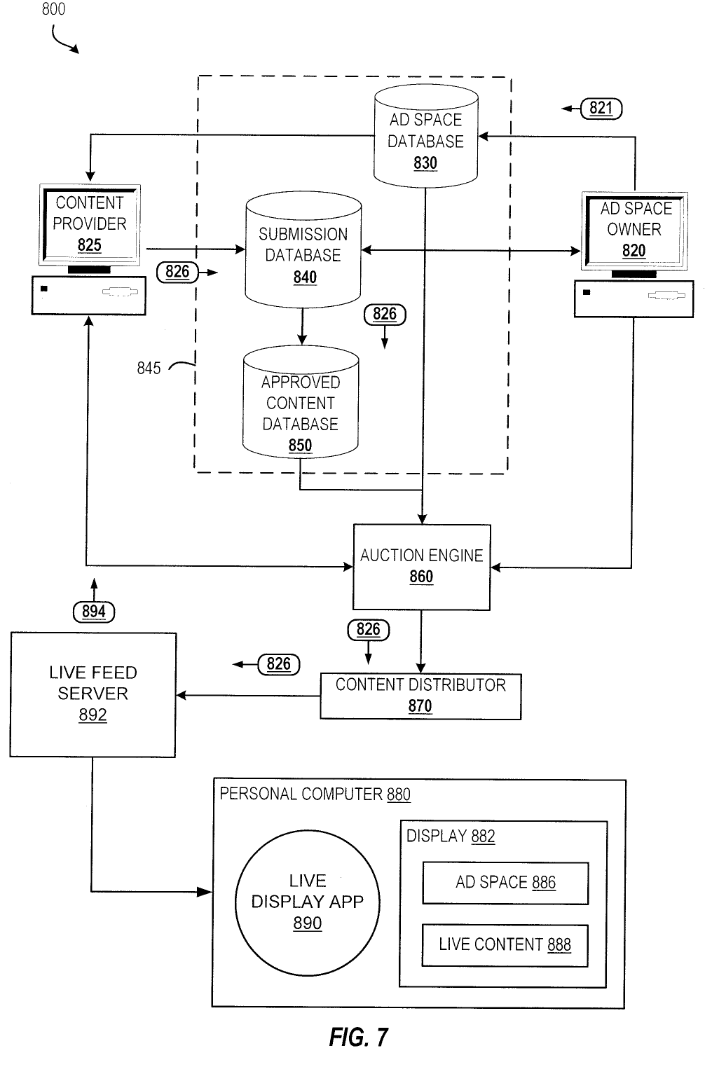

The term digital signage may also be used to indicate other kinds of graphical and textual displays, such as that of a personal computer. FIG. 7 schematically shows one system 800 for real-time allocation of digital content to one or more personal computers 880. A live feed server 892 operates to feed live (i.e., continually or periodically updated) information to a live display application 890 running on personal computer 880. Live display application 890 displays this live information (illustratively shown as live content 888) on a display 882 of personal computer 880. In one example, live feed server 892 supplies live information (such as information displayed on a stadium display) to personal computer 880, thereby allowing a user of personal computer 880 to view the live information. Fenway Park for example utilizes live feed server 892 to feed live baseball scores to a plurality of live display applications 890, each running on personal computers 880. Live feed server 892 and live display application 890 also includes advertising space 886 on display 882. In another example, Fenway park utilizes live feed server 892 to send a digital video feed (as displayed upon the stadium display) to each personal computer 880, and the live feed may be interspersed with advertising space that is auctioned by system 800. For example, where video displayed within the stadium in interspersed with advertisement, these advertisement time slots may be auctioned by system 800 such that digital content associated with the winning bid appears upon display 882 of personal computer 880.

An advertising space database 830 is populated with information (e.g., advertising space information 821) by advertising space owner 820; advertising space owner 820 may own and operate live feed server 892. Owner 820 for example pays a fee to register advertising space 886 with system 800. Advertising space database 830 contains information of live feed server 892, including pertinent details associated with selling advertising space 886 and time on display 882 of personal computer 880. A content provider 825 (also shown as a computer terminal communicatively connected with system 800) searches advertising space database 830 for an advertising space that meets desired advertising criteria. In one example, content provider 825 accesses advertising space database 830 via the Internet using the illustrated computer terminal. Upon selecting a suitable advertising space (e.g., advertising space 886 in this example) from advertising space database 830, content provider 825 submits content 826, such as digital media that is properly formatted and tagged for advertising space 886, to a submission database 840. It will be appreciated that while content 826 may be a conventional advertisement or commercial, content 826 may also be any graphical and/or textual digital content, including but not limited to: emergency postings (e.g., by the National Weather Service), public service information, such as information pertaining to road conditions or closures; a personal message or greeting; an announcement; an e-mail address; a photograph; a video clip, a survey and the like.

Advertising space owner 820 accesses submission database 840 to evaluate content 826 submitted advertising space 886. If approved, content 826 is stored in an approved content database 850. Advertising space database 830, submission database 840 and approved content database 850 may be part of the same database 845, as shown. In one example, submission database 840 and approved content database 850 are subsets of a single content database (not shown). In one embodiment, submission database 840 and approved content database 850 are combined and include one or more fields associated with each item of submitted content, to indicate approval or disapproval for selected advertising spaces. Approved content database 850 thus includes content (e.g., content 826) that is suitable (per criteria of advertising space owner 820) and ready to be displayed within advertising space 886. Content provider 825 is therefore eligible to participate in an auction for one or more time slots of advertising space 886 in which to display the content. Potential content for advertising space 886 is “approved” by owner 820 in advance of any time slot auction associated with advertising space 886, and may be loaded into memory of live feed server 892 such that it is ready to be displayed within advertising space 886 of dynamic display 882. Content (e.g., content 826) may be approved by multiple advertising space owners for playing within multiple advertising spaces.

An auction engine 860 matches content providers 825 to advertising space owners 820 based upon approved content for each advertising space (e.g., advertising space 886), and then determines which, if any, approved content is selected for display within the advertising space using a bidding methodology. Auction engine 860 employs one or more bidding methodologies defined by each advertising space owner (e.g., owner 820). Bidding methodologies include, but are not limited to, fixed or variable price, pricing granularity and using a traditional or reverse auction style. In an embodiment, auction engine 860 creates a virtual “wall” between content provider 825 and advertising space owner 820 such that the bidding methodology, the reserve price for time slots, the maximum bid and the latest bid are not available to the content providers and/or advertising space owners (e.g., the advertising space owner is not aware of the content provider's maximum bid and the content provider is not aware of the reserve price for a time slots of the advertising space).

Upon closing of an auction for a particular timeslot, auction engine 860 passes the identification of the winning content (content 826 in this example) and associated provider 825 to a content distributor 870. Content distributor 870 then distributes the winning content (or identification thereof where approved content has already been distributed and stored within memory of live feed server 892) to live feed server 892. This content distribution may be similar to distribution in existing web server architectures, with enhancements to permit real time operation. Where live feed server 892 has limited local storage, content distributor 870 may evaluate the speed of potential content distribution paths to ensure that the auction ends soon enough to allow any content to be delivered to the server prior to scheduled display time. Live feed server 892 has local storage to hold approved content (e.g., sufficient local storage to hold all approved content for advertising space 886 for an appropriate period, such as ten minutes). This local storage is updated by content distributor 870 to ensure that content for display within advertising space 886 is local prior to its designated time slot. Thus, when an auction ends, content distributor 870 transfers the identity of the winning content to live feed server 892 and any content no longer required may be flushed from the web server's local storage.

In an embodiment, advertising space database 830, submission database 840, approved content database 850, auction engine 860 and content distributor 870 are located on a server that is accessible by both owner 820 and content provider 825. In another embodiment, content distributor 870 is a wireless device that is remote from a server that includes databases 830, 840 and 850 and auction engine 860. Advertising space database 830, submission database 840, approved content database 850 and auction engine 860 may be located on a single server, multiple server(s) at a single location or multiple servers at a number of locations.

Since live feed server 892 receives other content for display on personal computer 880, such as a live feed from a stadium display during a sporting event, display 882 shows live content 888 from the live feed and content resulting from a real-time auction (i.e., through the use of system 800) of advertising space 886.

In one example, live feed server 880 divides connected personal computers 880 into geographic regions (such as states) as sells advertising space 886 based upon those geographic regions. Thus, system 800 may hold multiple auctions for each time slot of advertising space 886. Further, system 800 may provide content to more than one live feed server without departing from the scope hereof.

Live feed server 892 may collect statistical information (e.g., a number of connected live display applications 890 within each geographic area) that is fed back to system 800 as feedback 894. Feedback 894 may be used by auction engine 860 when evaluating bidding parameters of content providers 825 for each time slot of advertising space 886. That is, content providers 825 may specify bidding rules based upon feedback 892.

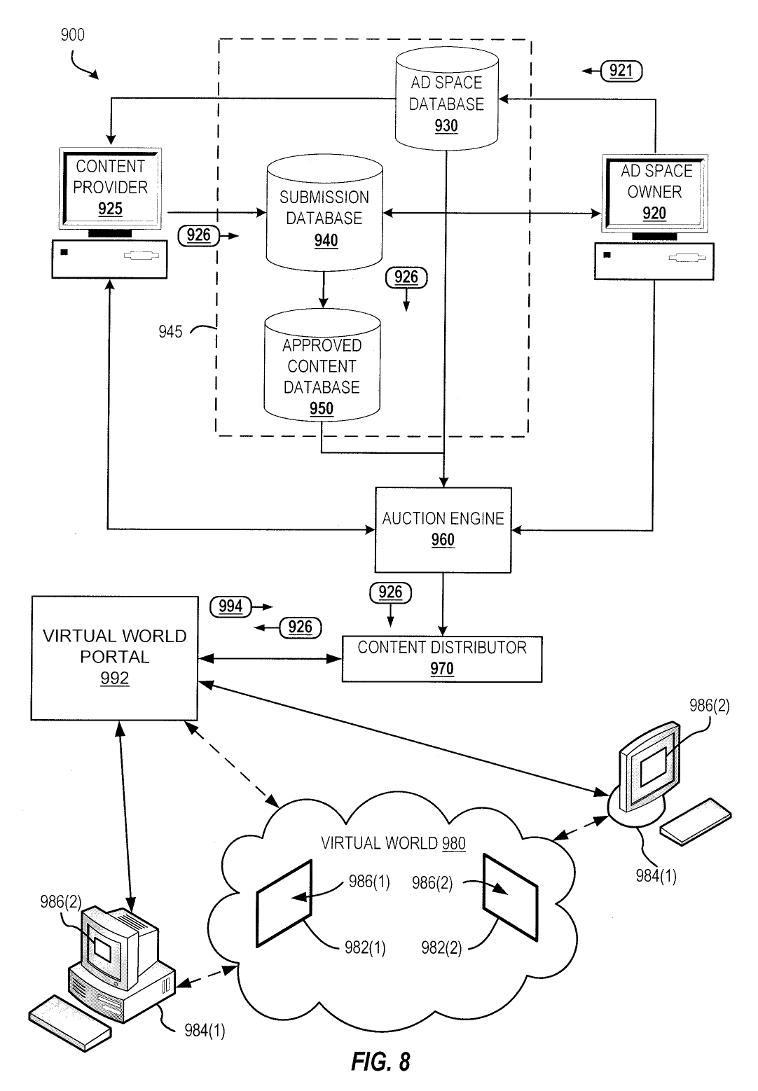

FIG. 8 schematically shows one system 900 for real-time allocation of digital content to one or more virtual displays 982 within a virtual world 980 (e.g., an online simulation and/or game world). Virtual world 980 is generated by a virtual world portal 992 that provides an interface to one or more users 984, who may view and interact with virtual world 980. Virtual displays 982 represent areas within virtual world 980 where advertising information may be displayed such that this advertising information is presented to users 984 as they view and interact with virtual world 980. In one example, virtual display 982(1) appears as a billboard display within a racing game that is formed as virtual world 980; that is, in this example, virtual world 980 represents an interactive racing game that is played by users 984. In another example, virtual display 982(2) appears as a display wall of a shop within a virtual world such as SecondLife™; virtual world portal 992 generates views of the display wall (and its digital content) as users interact with the virtual world such that the display wall is within their virtual view.

An advertising space database 930 is populated with information (e.g., advertising space information 921) by advertising space owner 920; advertising space owner 920 may own and operate virtual world portal 992. Owner 920 for example pays a fee to register advertising space(s) 986 with system 900. Advertising space database 930 contains information of virtual world portal 992, including pertinent details associated with selling advertising space(s) 986 and time on virtual display(s) 982 within virtual world 980. A content provider 925 (also shown as a computer terminal communicatively connected with system 900) searches advertising space database 930 for an advertising space that meets desired advertising criteria. In one example, content provider 925 accesses advertising space database 930 via the Internet using the illustrated computer terminal. Upon selecting a suitable advertising space (e.g., advertising space 986 in this example) from advertising space database 930, content provider 925 submits content 926, such as digital media that is properly formatted and tagged for advertising space 986, to a submission database 940. It will be appreciated that while content 926 may be a conventional advertisement or commercial, content 926 may also be any graphical and/or textual digital content, including but not limited to: emergency postings (e.g., by the National Weather Service), public service information, such as information pertaining to road conditions or closures; a personal message or greeting; an announcement; an e-mail address; a photograph; a video clip, a survey and the like.

Advertising space owner 920 accesses submission database 940 to evaluate content 926 submitted advertising space 986. If approved, content 926 is stored in an approved content database 950. Advertising space database 930, submission database 940 and approved content database 950 may be part of the same database 945, as shown. In one example, submission database 940 and approved content database 950 are subsets of a single content database (not shown). In one embodiment, submission database 940 and approved content database 950 are combined and include one or more fields associated with each item of submitted content, to indicate approval or disapproval for selected advertising spaces. Approved content database 950 thus includes content (e.g., content 926) that is suitable (per criteria of advertising space owner 920) and ready to be displayed within advertising space 986. Content provider 925 is therefore eligible to participate in an auction for one or more time slots of advertising space 986 in which to display the content. Potential content for advertising space 986 is “approved” by owner 920 in advance of any time slot auction associated with advertising space 986, and may be loaded into memory of virtual world portal 992 such that it is ready to be displayed within advertising space 986 of virtual display 982. Content (e.g., content 926) may be approved by multiple advertising space owners for playing within multiple advertising spaces.

An auction engine 960 matches content providers 925 to advertising space owners 920 based upon approved content for each advertising space (e.g., advertising space 986), and then determines which, if any, approved content is selected for display within the advertising space using a bidding methodology. Auction engine 960 employs one or more bidding methodologies defined by each advertising space owner (e.g., owner 920). Bidding methodologies include, but are not limited to, fixed or variable price, pricing granularity and using a traditional or reverse auction style. In an embodiment, auction engine 960 creates a virtual “wall” between content provider 925 and advertising space owner 920 such that the bidding methodology, the reserve price for time slots, the maximum bid and the latest bid are not available to the content providers and/or advertising space owners (e.g., the advertising space owner is not aware of the content provider's maximum bid and the content provider is not aware of the reserve price for a time slots of the advertising space).

Upon closing of an auction for a particular timeslot, auction engine 960 passes the identification of the winning content (content 926 in this example) and associated provider 925 to a content distributor 970. Content distributor 970 then distributes the winning content (or identification thereof where approved content has already been distributed and stored within memory of virtual world portal 992) to virtual world portal 992. This content distribution may be similar to distribution in existing web server architectures, with enhancements to permit real time operation. Where virtual world portal 992 has limited local storage, content distributor 970 may evaluate the speed of potential content distribution paths to ensure that the auction ends soon enough to allow any content to be delivered to the server prior to scheduled display time. Virtual world portal 992 has local storage to hold approved content (e.g., sufficient local storage to hold all approved content for advertising space 986 for an appropriate period, such as ten minutes). This local storage is updated by content distributor 970 to ensure that content for display within advertising space 986 is local prior to its designated time slot. Thus, when an auction ends, content distributor 970 transfers the identity of the winning content to virtual world portal 992 and any content no longer required may be flushed from the web server's local storage.

In an embodiment, advertising space database 930, submission database 940, approved content database 950, auction engine 960 and content distributor 970 are located on a server that is accessible by both owner 920 and content provider 925. In another embodiment, content distributor 970 is a wireless device that is remote from a server that includes databases 930, 940 and 950 and auction engine 960. Advertising space database 930, submission database 940, approved content database 950 and auction engine 960 may be located on a single server, multiple server(s) at a single location or multiple servers at a number of locations.

Virtual world portal 992 generates one or more views of virtual world 980, based upon interaction by users 984, and includes content resulting from a real-time auction (i.e., through the use of system 900) within advertising space 986 when advertising space 986 falls within those generated views. That is, virtual world portal 992 generates virtual display 982 with the appropriate digital content (shown as generated display 986) when virtual display 982 falls within the view of user 984.

In one embodiment, ad space owner 920 and virtual world portal 992 divide connected users 984 into geographic regions (such as states) and sell advertising space 986 based upon those geographic regions. Thus, system 900 may hold multiple auctions for each time slot of advertising space 986 (i.e., one for each geographic region) thereby allowing digital content to be localized to each geographic region. Further, system 900 may provide content to more than one virtual world portal (i.e., for display within multiple games and virtual worlds) without departing from the scope hereof.

Virtual world portal 992 may collect statistical information (e.g., a number of connected users 984 within each geographic area) that is fed back to system 900 as feedback 994. Feedback 994 may be used by auction engine 960 when evaluating bidding parameters of content providers 925 for each time slot of advertising space 986. That is, content providers 925 may specify bidding rules based upon feedback 994.

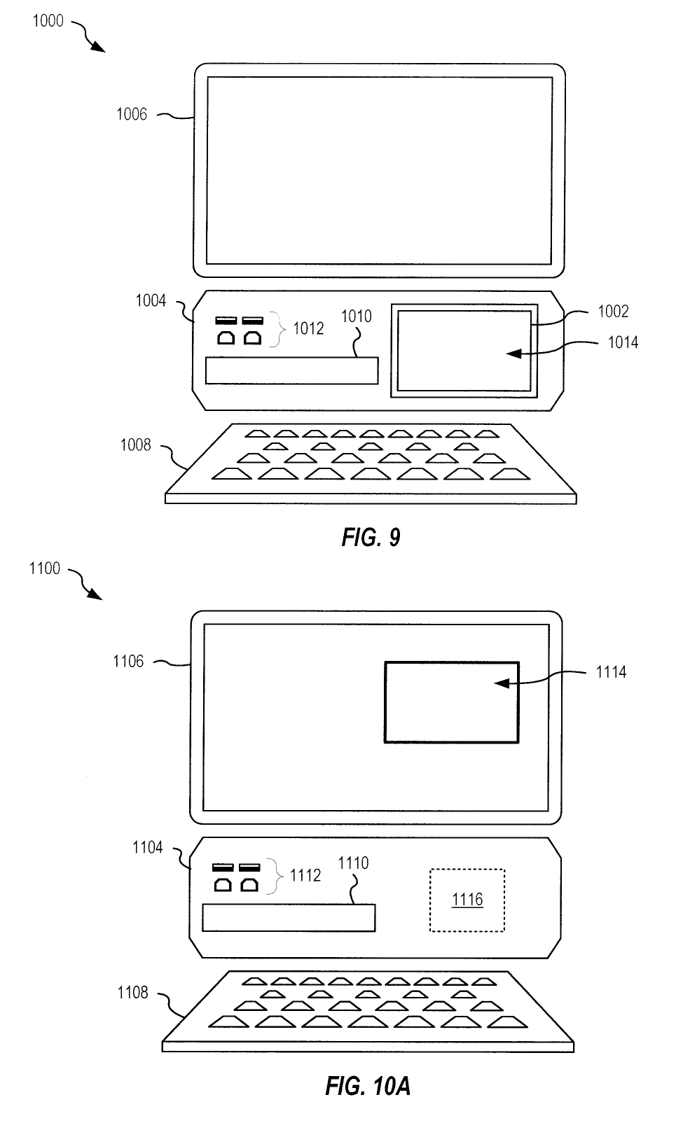

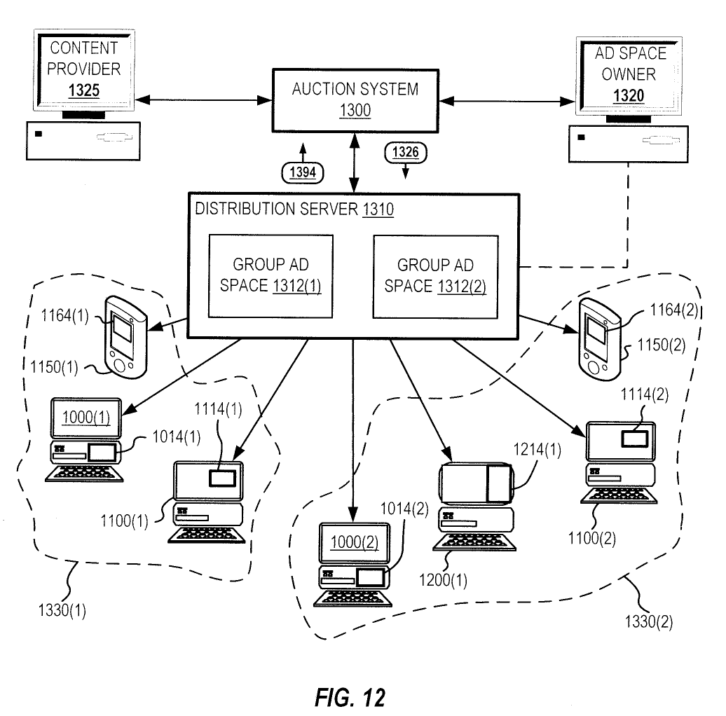

FIG. 9 shows one exemplary personal computer 1000 fitted with a permanent advertisement display screen 1002. Computer 1000 is shown with a processor case 1004, a computer display 1006, a keyboard 1008, an optical drive 1010 (e.g., a DVD reader) and a plurality of interface ports 1012. Computer 1000 may represent a personal computer, as purchased by home or office users, with the addition of advertisement display 1002. In one example, advertisement display 1002 includes a permanent advertising space 1014 that is owned by an advertising space owner (e.g., ad space owner 1320, FIG. 12). Display 1002 may be supplied with computer 1000 as part of a discount package for computer 1000. That is, the cost of computer 1000 is discounted because of the inclusion of permanent advertisement display 1002.

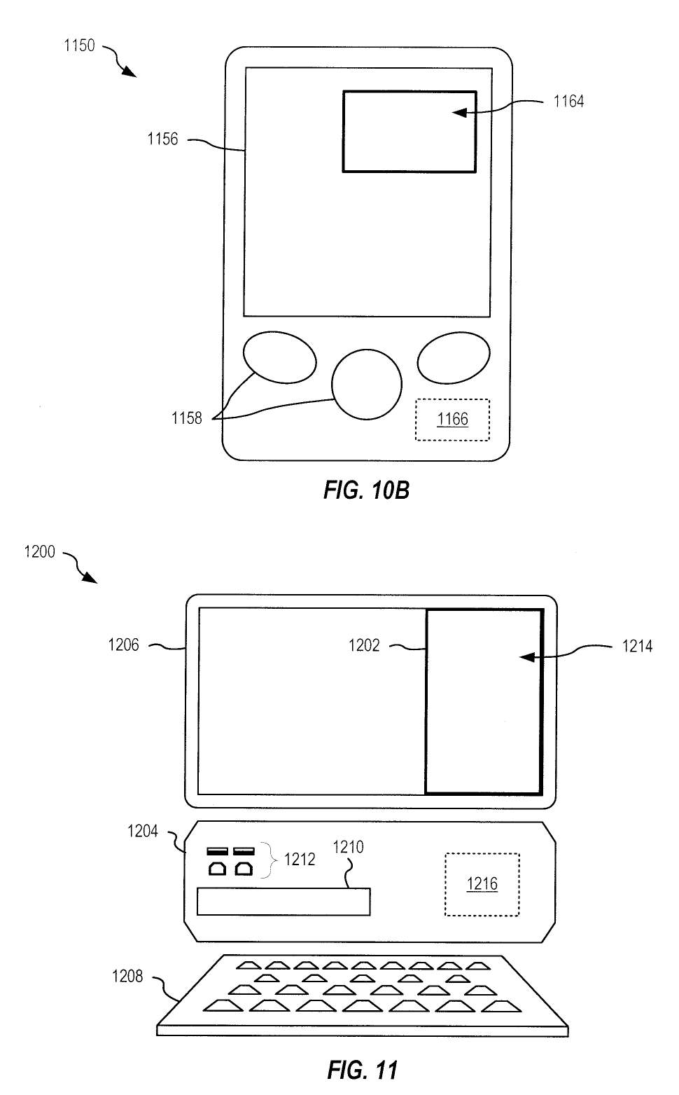

FIG. 10A shows one exemplary personal computer 1100 configured to permanently display an advertising space 1114. Computer 1100 is shown with a processor case 1104, a computer display 1106, a keyboard 1108, an optical drive 1110 (e.g., a DVD reader) and a plurality of interface ports 1112. Computer 1100 may represent a personal computer, as purchased by home or office users, with the addition of a device 1116 (hardware and/or software) that displays advertising space 1114 on display 1106 whenever computer 1100 is operational (i.e., powered on and in use). In one example, advertising space 1114 is owned by an advertising space owner (e.g., ad space owner 1320, FIG. 12) and device 1116 is supplied with computer 1100 as part of a discount package for computer 1100. That is, the cost of computer 1100 is discounted because of the inclusion of device 1116. Advertising space 1114 may be repositioned on screen 1106, but cannot be removed or reduced in size by the user of computer 1100.

FIG. 10B shows one exemplary personal communication device 1150 configured to permanently display an advertising space 11164. Device 1150 is shown with a display 1156 and a plurality of input keys 1158; device 1150 may have other input and output means (e.g., microphone, speaker, touch screen, and so on) without departing from the scope hereof Device 1150 may represent a personal digital assistant (PDA), a cell phone, a smart phone, a GPS navigation system (e.g., as used in a car), or other display device having communication capability, with the addition of a device 1166 (hardware and/or software) that displays advertising space 1164 on display 1156 whenever device 1150 is operational (i.e., powered on and in use). In one example, advertising space 1164 is owned by an advertising space owner (e.g., ad space owner 1320, FIG. 12) and device 1166 is supplied with device 1150 as part of a discount package for device 1150. In an embodiment, advertising space 1164 is permanently sized and positioned on display 1156. In another embodiment, advertising space 1164 may be repositioned on display 1156, but cannot be removed or reduced in size by a user of device 1150.

FIG. 11 shows one exemplary personal computer 1200 configured to permanently display an advertising space 1214 within a fixed portion 1202 of display 1206. Computer 1200 is shown with a processor case 1204, computer display 1206, a keyboard 1208, an optical drive 1210 (e.g., a DVD reader) and a plurality of interface ports 1212. Computer 1200 may represent a personal computer, as purchased by home or office users, with the addition of a hardware device 1216 that displays advertisements space 1214 on screen 1206 within portion 1202 whenever computer 1200 is operational (i.e., powered on and in use). In one example, advertising space 1214 is owned by an advertising space owner (e.g., ad space owner 1320, FIG. 12) and device 1216 is supplied within computer 1200 as part of a discount package for computer 1200. That is, the cost of computer 1200 is discounted because of the inclusion of device 1216. Hardware device 1216 only allows digital content to be displayed within portion 1202 of display 1206; portion 1202 cannot be removed or reduced in size by the user of computer 1200. Alternately, portion 1202 may be reduced to a pre-set minimum size, but not removed by the user of computer 1200.

FIG. 12 shows one exemplary auction system 1300 for providing digital content to advertising spaces 1014, 1114, 1214 and 1164 of computers 1000, 1100, 1200, and devices 1150 respectively (shown with select computers and devices). Auction system 1300 represents one of system 10, FIG. 1A, system 700, FIG. 6, system 800, FIG. 7, and system 900, FIG. 8. For example, system 1300 contains an advertisement sign/advertisement database (e.g., one of advertisement sign database 30, advertising space database 830, and advertising space database 930), a submission database (e.g., one of submission database 40, submission database 840, and submission database 940), approved content database 50, approved content database 850, and approved content database 950), an auction engine (e.g., one of auction engine 60, auction engine 860, and auction engine 960), and a content distributor (e.g., one of content distributor 70, content distributor 870, and content distributor 970).

In the example of FIG. 12, an advertising space owner 1320 owns advertising spaces of computers 1000, 1100, 1200 and devices 11150. See FIGS. 9, 10A, 10B and 11 and description above. Computers 1000, 1100, 1200 and devices 1150 are shown distributed over two geographic areas 1330(1) and 1330(2), with computers 1000(1) and 1100(1) and device 1150(1) located within geographic area 1330(1) and computers 1000(2), 1100(2), 1200(1) and device 1150(2) located within geographic area 1330(2). Advertising space owner 1320 may own advertising space of computers and devices in fewer or more geographic areas 1330 without departing from the scope hereof. Each geographic area 1330 may contain more or fewer computers and devices than illustrated without departing from the scope hereof.

Advertising space owner 1320 may create and sell advertising space on personal computers 1000, 1100, 1200 and devices 1150 based upon geographic location. For example, advertising space owner 1320 may sell advertising space of personal computers 1000(2), 1100(2), 1200(1) and device 1150(2) that are within geographic area 1330(2) as group advertising space 1312(2). Similarly, advertising space owner 1320 may sell advertising space of personal computers 1000(1), 1100(1) and device 1150(1) that are within geographic area 1330(1) as group advertising space 1312(1). Group advertising spaces 1312 are shown within distribution server 1310 of advertising space owner 1320 for purposes of illustration. It should also be noted that advertising space owner 1320 may group advertising space of personal computers 1000, 1100, 1200 and devices 1150 in other ways without departing from the scope hereof. For example, advertising space owner 1320 may group personal computers 1000, 1100, 1200 and devices 1150 based upon other demographics, such as the age and/or gender of the user. That is, advertising space owner 1320 may auction group advertising spaces 1312 where each is based upon a different personal computer user demographic. In another example, advertising space owner 1320 may group personal computers 1000, 1100, 1200 and devices 1150 based upon a size of advertising spaces 1014, 1114, 1214 and 1164, respectively. Advertising space owner 1320 may thus auction one or more group advertising spaces 1312.

Advertising space owner 1320 supplies information of group advertising spaces 1312 to auction system 1300. For example, advertising space owner 1320 enters details of group advertising spaces 1312 within an advertising space database (not shown) of auction system 1300, such that one or more content providers 1325 may provide content for, and bid upon, these group advertising spaces 1312, as described above for systems 800 and 900. As described above for system 800 and 900, auction system 1300 auctions each group advertising space 1312 and provides approved digital content 1326 to distribution server 1310 for distribution, upon winning the auction, to appropriate personal computers 1000, 1100, 1200 and devices 1150. Optionally, distribution server 1310 may provide feedback information 1394 to auction system 1300 for evaluation during auctions of group advertising spaces 1312. For example, information 1394 may include the number of computers 1000, 1100, 1200 and devices 1150 currently online, the number of computers and devices within geographic area 1330, and other applicable demographics of the computer and device users. Auction system 1300 may then evaluate information 1394 against bidding rules of content providers 1325 to determine winning content (e.g., approved content 1326) for advertising spaces 1312.

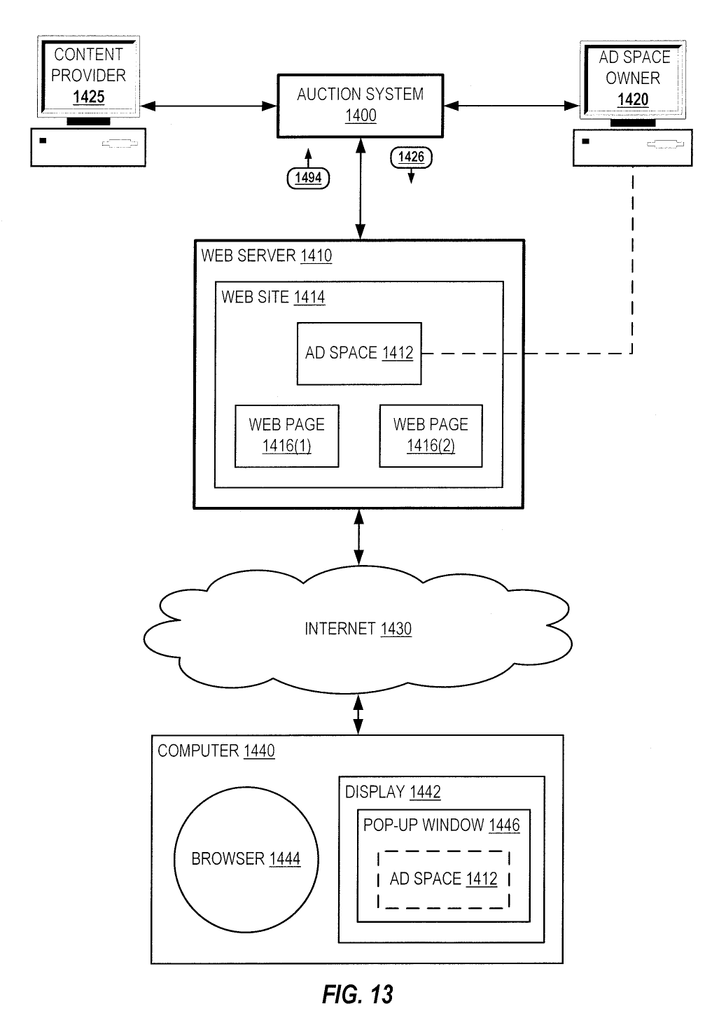

FIG. 13 shows one exemplary auction system 1400 for providing digital content to advertising spaces 1412 of web site 1414. Auction system 1400 may represent one of system 10, FIG. 1A, system 700, FIG. 6, system 800, FIG. 7, system 900, FIG. 8, and system 1300, FIG. 12, and operate in a manner similar thereto. Web site 1414 is shown with two exemplary web pages 1416(1) and 1416(2) and is provided by a web server 1410. Advertising space 1412 is purchased by advertising space owner 1420 and registered with auction system 1400. Alternatively, advertising space owner 1420 also owns web site 1414, and thereby advertising space 1412. A content provider 1425 may then enter a bid for advertising space 1412 within auction system 1400. Upon approval of submitted digital content and winning an auction for advertising space 1412, digital content 1426 is transferred to web server 1410 for display in association with web site 1414.

A computer 1440 is shown with a display 1442, a web browser 1444 and connectivity to Internet 1430. Computer 1440 may represent one or more of a personal computer, a laptop computer, a PDA, a smart phone, an interactive GPS navigation device, and other similar devices having a browser, a display screen and Internet connectivity. Browser 1444, under control of a user of computer 1440, accesses web pages 1416 of web site 1414 via Internet 1430, displaying the selected web page upon display 1442. In an embodiment, upon accessing web site 1414, browser 1444 displays a pop-up window 1446 that includes advertising space 1412. That is, each web browser accessing web site 1414 displays a pop-up window 1446 containing advertising space 1412 to display winning approved digital content 1426 for advertising space 1412. Pop-up window 1446 may remain on display 1442 for the duration that browser 1444 accesses web site 1414; pop-up window 1446 may be configured as a floating window that cannot be removed or moved off of display 1442 while browser 1444 accesses web site 1414. In an alternate embodiment, advertising space 1412 appears as part of one or more web pages 1416 of web site 1414. That is, advertising space 1412 may be scrolled as part of one or more web pages 1416.

In another aspect, digital content 1426 appears within a permanent advertising space (e.g., space 1114, FIG. 10A) of a personal computer (e.g., computer 1100) while browser 1444 accesses web site 1414. In other words, a permanent advertising space supplied with a discounted computer may replace or complement pop-up window 1446 as a site for display of winning content.

Web server 1410 may provide feedback information 1494 to auction system 1400 for evaluation during auctions of advertising space 1412. For example, information 1494 may include the number of computers 1440 (or other web browsing terminals and devices) currently connected to web site 1414, and geographic and other determined demographics of users of personal computers 1440. Auction system 1400 may then evaluate information 1494 against bidding rules of content providers 1425 to determine winning content (e.g., approved content 1426) for advertising space 1412.

Changes may be made in the above systems and methods without departing from the scope hereof. For example, the method steps described herein need not occur in the order in which they are presented. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A system for real-time allocation of digital content to an advertising space, comprising:
an advertising space database including information representative of one or more advertising spaces;
a content database for storing digital content from at least one content provider, the content database being reviewable;
an auction engine for matching the digital content to the advertising space; and
a content distributor for distributing the matched digital content to the advertising space.

2. The system of claim 1, the advertising space being displayed on a virtual display within a virtual world generated by a virtual world portal.

3. The system of claim 2, the virtual display and the advertising space being displayed on interfaces with the virtual world portal to interact with the virtual world.

4. The system of claim 2, the virtual world portal providing feedback to the auction engine, the feedback comprising statistical information.

5. The system of claim 4, the statistical information comprising a number of users within a geographic area currently interfacing with the virtual world portal.

6. The system of claim 2, the virtual world being a simulation generated by the virtual world portal.

7. The system of claim 2, the virtual world being a game generated by the virtual world portal.

8. The system of claim 1, the advertising space being displayed on a device.

9. The system of claim 8, the device being a desktop computer with an additional display containing the advertising space.

10. The system of claim 8, the device being a desktop computer having a display, a portion of the display permanently displaying the advertising space.

11. The system of claim 8, the device being a desktop computer having a display, the advertising space being permanently displayed within a window on the display.

12. The system of claim 11, the window having a minimum size.

13. The system of claim 11, the window being repositionable within the display.

14. The system of claim 8, the device being a portable device selected from the group including a cell phone, a smart phone, a personal digital assistant, and a global positioning system (GPS) navigation device.

15. The system of claim 1, the advertising space being displayed within a pop-up window of a browser.

16. The system of claim 15, the pop-up window displaying the advertising space when the user views one or more pages of a website, the advertising space being associated with the website.

17. The system of claim 1, the content database comprising:
a submitted content database for processing submission of digital content from the content provider; and
an approved content database for storing digital content from the submitted content database that is approved.

18. The system of claim 17, the submitted content database and the approved content database comprising subsets of the content database.

19. The system of claim 17, the approved content database comprising digital content that is tagged with an approval indicator.

20. The system of claim 17, the digital content in the approved content database comprising digital media approved for play within the advertising space in one or more selected time slots.

21. The system of claim 17, wherein the approved content database stores content approved for play within one or more owned advertising spaces.

22. The system of claim 17, wherein the digital content in the approved content database is rated.

23. The system of claim 17, wherein the digital content in the approved content database has an expiry date.

24. The system of claim 1, wherein the advertising space database contains information representative of advertising spaces of one or more advertising space owners.

25. The system of claim 1, the digital content in the content database comprising an assigned rating.

26. The system of claim 1, the content database being accessible by multiple advertising space owners.

27. The system of claim 1, the digital content having a supplied valid date, the valid date specifying a period when the digital content is available for display.

28. The system of claim 1, wherein functionality of the auction engine is determined by advertising space owner parameters.

29. The system of claim 28, the parameters comprising one or more of a geographic area where the advertising space is viewed, pixels of the advertising space, resolution of the advertising space, refresh rate of the advertising space, spot duration of the advertising space, spot time of the advertising space, anticipated impressions as a function of time of day, anticipated length of impression, anticipated viewer demographics, acceptable content ratings for the advertising space, pricing granularity of the advertising space, and type of auction for the advertising space.

30. The system of claim 1, wherein functionality of the auction engine is determined by content provider parameters.

31. The system of claim 30, the parameters comprising one or more of pixels, resolution, refresh rate, spot duration, spot time, times of advertising space operation, location of advertising space, anticipated impressions as a function of time of day, anticipated length of impression, anticipated viewer demographics and maximum price.

32. The system of claim 1, the matched content comprising bundled content and bundle parameters, the bundle parameters being utilized to select the digital content for distribution.

33. A method for real-time allocation of digital content to advertising spaces, comprising:
processing advertising space parameters for an advertising space in an advertising space database;
processing sales parameters for the advertising space in the advertising space database;
processing digital content in a submitted content database;
permitting access to the submitted content database for review of the digital content by an advertising space owner;
tagging approved digital content with an approval indicator;
processing bidding parameters for a time slot on the advertising space;
auctioning the time slot to providers of the approved digital content;
distributing the approved digital content to the advertising space; and
airing winning digital content during the time slot.

34. The method of claim 33, wherein the step of processing advertising space parameters comprises processing parameters for two or more advertising spaces.

35. The method of claim 33, wherein auctioning is performed according to an auction style selected by the advertising space owner.

36. The method of claim 35, the auction style comprising reverse auctioning or traditional auctioning.

37. The method of claim 33, wherein the step of processing sales parameters for the advertising space is performed as a function of one or both of the time slot and a pre-selected auction style.

38. The method of claim 33, wherein tagging digital content comprises tagging digital content that is approved for two or more advertising spaces.

39. The method of claim 33, wherein tagging digital content comprises tagging digital content that is approved for two or more time slots on the advertising space.

40. The method of claim 33, wherein distributing the approved digital content to the advertising space comprises distributing a portion or all of the approved digital content to the advertising space.

41. The method of claim 40, further comprising removing losing approved content from the advertising space.

42. The method of claim 33, wherein distributing content to the advertising space comprises determining content from bundled content based upon associated bundle parameters.

43. The method of claim 33, further comprising:
processing advertising space parameters for a second advertising space in the advertising space database;
processing sales parameters for the second advertising space in the advertising space database;
tagging approved digital content for the second advertising space;
processing bidding parameters for a time slot on the second advertising space;
auctioning the time slot on the second advertising space to one or more providers of the approved digital content;
distributing the approved digital content to the second advertising space; and
airing winning digital content on the second advertising space during the time slot.

44. The method of claim 33, further comprising accepting bidding parameters from the content provider.

45. The method of claim 44, wherein the bidding parameters are received immediately prior to commencement of the time slot.

46. A software product comprising instructions, stored on computer-readable media, wherein the instructions, when executed by a computer, perform steps for real-time allocation of digital content to advertising spaces, comprising:
instructions for obtaining data indicative of advertising space owner parameters;
instructions for obtaining data indicative of content provider parameters;
instructions for identifying approved content;
instructions for carrying out an auction; and
instructions for distributing approved content to one or more advertising spaces.

47. A method for real-time allocation of digital content to advertising spaces, comprising:
processing advertising space parameters for an advertising space in an advertising space database;
processing sales parameters for the advertising space in the advertising space database;
processing digital content in a submitted content database;
permitting access to the submitted content database by an advertising space owner, for review of the digital content;
tagging approved digital content with an approval indicator;
processing bidding parameters for a time slot on the advertising space;
auctioning the time slot to providers of the approved digital content based upon the bidding parameters and the sales parameters;
distributing the approved digital content to the advertising space; and
airing the approved digital content of the winning provider on the advertising space during the time slot.
